(19) United States
(12) Patent Application Publication
(10) Pub. No.: US 2019/0074146 A1
(43) Pub. Date: Mar. 7, 2019

(54) SWITCHING DEVICE AND SYSTEM FOR SWITCHING ON AND OFF AN ELECTRICAL LOAD

(71) Applicant: Phoenix Contact GmbH & Co. KG, Blomberg (DE)

(72) Inventors: Andre KORREK, Marienmünster (DE); Bernd SCHULZ, Hoxter (DE)

(73) Assignee: Phoenix Contact GmbH & Co. KG, Blomberg (DE)

(21) Appl. No.: 15/779,261

(22) PCT Filed: Nov. 25, 2016
(86) PCT No.: PCT/EP2016/078826

§ 371 Date: Nov. 6, 2018

(30) Foreign Application Priority Data
Nov. 27, 2015 (DE) 10 2015 120 666.8

(51) Int. Cl. H01H 9/54; H02H 3/08; H02P 29/024; H02P 3/22

(52) U.S. Cl. CPC H01H 9/541; H02P 3/22; H02P 29/025; H02H 3/08

(57) ABSTRACT

A switching device for switching an electrical load on or off has an internal energy store which, when the supply voltage is switched off, may deliver the excitation energy, necessary for controlling electromechanical switches, directly to at least one of the electromechanical switches for a predetermined time period. For this purpose, a control unit appropriately controls at least two switching units. The switching units are each part of an energy flow limiting device, in particular an optocoupler, in order to achieve a sufficiently high separation, in terms of energy, between a first terminal and a second terminal. The switching device also has an input stage that may provide a digital control signal for the control unit, which signals the application or the non-application of a supply voltage.

### FIELD

The invention relates to a switching device for switching an electrical load, in particular an electric motor, on or off, and a system having such a switching device for switching an electrical load on or off.

### BACKGROUND

Switching devices that are used as motor starters in automation technology, for example, are known.

A switching device for controlling the supply of energy to a downstream electric motor is described in WO 2014/032718 A1, for example. The switching device has a supply terminal to which a supply source, which delivers a supply voltage of 24 volts, for example, may be connected via an emergency stop switch. In addition, the known switching device has terminals for connecting to a supply grid. Further terminals are provided to allow an electric motor to be connected. Multiple electromechanical switches and semiconductor switches are provided to allow the electric motor to be connected to or disconnected from the supply grid. In addition, a control unit is implemented in the switching device, and by means of the electrical energy obtained via the supply terminal may output the required switching signals, i.e., the required excitation energy, to the particular switches. In addition, the switching device has an energy store that may supply electrical energy to the control unit when the supply voltage at the supply terminal drops into a critical range, so that the control unit is able to provide the required switching signals for the particular switches. In other words, the quantity of energy that is needed by the control unit to be able to close an electromechanical switch or keep it closed, and to keep a semiconductor switch in the conductive state, is supplied to the control unit via the supply terminal or by means of the energy store.

A similar switching device is known from WO 2014/075742, additionally having an internal power supply unit that supplies the control unit with the energy for switching signals of the switches.

One disadvantage of the known switching devices may be considered to be that all of the energy that is required for switching the electromechanical switches and the semiconductor switches is supplied to the switches via the control unit.

### SUMMARY

The object of the present invention, therefore, is to provide a switching device and a system that avoid this disadvantage.

A core concept of the invention may be regarded as providing a switching device having an energy store which delivers the energy, necessary for controlling at least one electromechanical switch, directly to the electromechanical switch.

A further aspect may be regarded to be that the control unit of the switching device is supplied only with energy for operation that is lower than the energy that is necessary for controlling the electromechanical switch.

The technical object stated above is achieved on the one hand by the features of claim 1.

Accordingly, a switching device for switching an electrical load on or off is provided, wherein the electrical load may be an electric motor, for example, in particular a three-phase motor.

The switching device has a first terminal for applying a first supply voltage via a safety switching device. The safety switching device may be an emergency stop switch, for example. A second terminal is provided at which a second supply voltage, which may feed an electrical load, may be applied. It is noted that the first supply voltage may be provided by a supply source that delivers, for example, a direct voltage of 24 V. The second supply voltage may be provided, for example, by a supply grid, in particular a three-phase low-voltage power grid, that delivers a voltage of 400 volts at 50 Hertz, for example.

Furthermore, a third terminal for connecting an electrical load is provided. The switching device also has a power output stage that is connected between the second and third terminals, and at least one electromechanical switch and at least one further switch for closing or interrupting a connection between the second and third terminals. An energy store internal to the device, which is chargeable to a predetermined energy level via the first terminal, is connected to the first terminal.

It is noted that the power output stage may be designed as a multiphase and/or multichannel power output stage, for example.

Moreover, a control unit and at least two switching units that are controllable by the control unit are implemented in the switching device, and in each case are able to connect the at least one electromechanical switch or the at least one further switch to the first terminal and to the energy store.

In addition, an input stage internal to the device is connected to the first terminal, and may provide a digital control signal for the control unit which signals the application or the non-application of the first supply voltage. The control unit is designed to control the at least two switching units, as a function of the digital control signal, in such a way that when the first supply voltage is present at the first terminal, the at least one electromechanical switch and the at least one further switch close, and that as soon as the first supply voltage has been disconnected from the first terminal, the energy store may supply the stored energy to the at least one electromechanical switch for the predetermined time period, so that the at least one electromechanical switch remains closed during the predetermined time period.

If the control unit requires a lower operating voltage than the at least one electromechanical switch, a power supply unit internal to the device which may supply the control unit with an operating voltage for a predetermined time period, in particular even when the first supply voltage has been switched off, may advantageously be connected to the first terminal and to the energy store.

The switching units may advantageously each be a part of an energy flow limiting device, in particular an optocoupler. In addition, the input stage may be coupled to the control unit via an energy limiting device, in particular an optocoupler.

The technical object stated above is likewise achieved by the features of claim 2.

Accordingly, a switching device for switching an electrical load on or off is provided. The switching device has a first terminal for applying a first supply voltage via a safety switching device, a second terminal for applying the first supply voltage or a second supply voltage, a third terminal for applying a third supply voltage which may feed an electrical load, and a fourth terminal for connecting an electrical load.

In addition, the switching device has a power output stage that is connected between the third and fourth terminals, and at least one electromechanical switch and at least one further switch for closing or interrupting a connection between the third and fourth terminals. An energy store internal to the device, which is chargeable to a predetermined energy level via the first terminal, is connected to the first terminal. A power supply unit internal to the device, which may supply the control unit with an operating voltage, is connected to the second terminal. The operating voltage may be less than the voltage required for operating the at least one electromechanical switch.

Also situated in the switching device are a control unit and at least two switching units which are controllable by the control unit, and which may connect the at least one electromechanical switch or the at least one further switch to the first terminal and to the energy store, the switching units each being a part of a first energy flow limiting device. In addition, a first input stage internal to the device is connected to the first terminal, and may provide a digital control signal for the control unit which signals the application or non-application of the first supply voltage, the first input stage being coupled to the control unit via a second energy flow limiting device. The control unit is designed to control the at least two switching units, as a function of the digital control signal, in such a way that when the first supply voltage is present at the first terminal, the at least one electromechanical switch and the at least one further switch close, and as soon as the first supply voltage has been disconnected from the first terminal, the energy store may supply the stored energy to the at least one electromechanical switch for a predetermined time period, so that the at least one electromechanical switch remains closed during the predetermined time period.

The primary task of the energy flow limiting devices is to provide that essentially little or no energy reaches the first terminal from the second terminal, thus ensuring that the at least one electromechanical switch and the at least one further switch are operated only via the supply voltage that is present at the first terminal or the energy that is stored in the energy store. Faulty control of the at least one electromechanical switch and of the at least one further switch is thus achieved by a sufficiently high energy flow barrier between the first terminal and the second terminal.

The first energy flow limiting devices and the second energy flow limiting device are advantageously optocouplers in each case. Even galvanic isolation between the first and the second terminal is achieved in this way.

To be able to switch the electrical load on or off operationally, i.e., in a noncritical state, a fifth terminal is provided for applying the first supply voltage via a main switch, for example. In addition, a second input stage associated with the fifth terminal is provided which may provide a digital control signal for the control unit, which signals the application or non-application of the first supply voltage. In this case, the energy flow limiting devices once again ensure that essentially little or no energy may reach the first terminal from the fifth terminal.

In addition, a monitoring device may optionally be provided which is connected to the power supply unit and the control unit. Such monitoring devices are known. For example, they may contain a motor model with which, for example, the operating temperature or the cooling time of the electrical load may be monitored over a fairly long time period, for example 20 minutes.

One advantageous refinement provides that a device for protecting against polarity reversal and/or for setting the predefined excitation energy to which the energy store is chargeable may be connected to the first terminal.

The at least one further switch is advantageously an electromechanical switch or a semiconductor switch.

The technical object stated above may also be achieved by the features of claim 10.

Accordingly, a system for switching an electrical load on or off is provided which has a switching device according to one of claims 1 to 9, a first energy supply source that is connectable to the first terminal, a second energy supply source that is connectable to the second or third terminal, and an electrical load that is connectable to the third or fourth terminal.

### BRIEF DESCRIPTION OF THE DRAWINGS

The invention is explained in greater detail below with reference to two exemplary embodiments in conjunction with the appended drawings, which show the following:

FIG. 1 shows a system by way of example for switching an electrical load on or off, in which the invention is implemented, and

FIG. 2 shows another system by way of example for switching an electrical load on or off, in which the invention is implemented.

### DETAILED DESCRIPTION

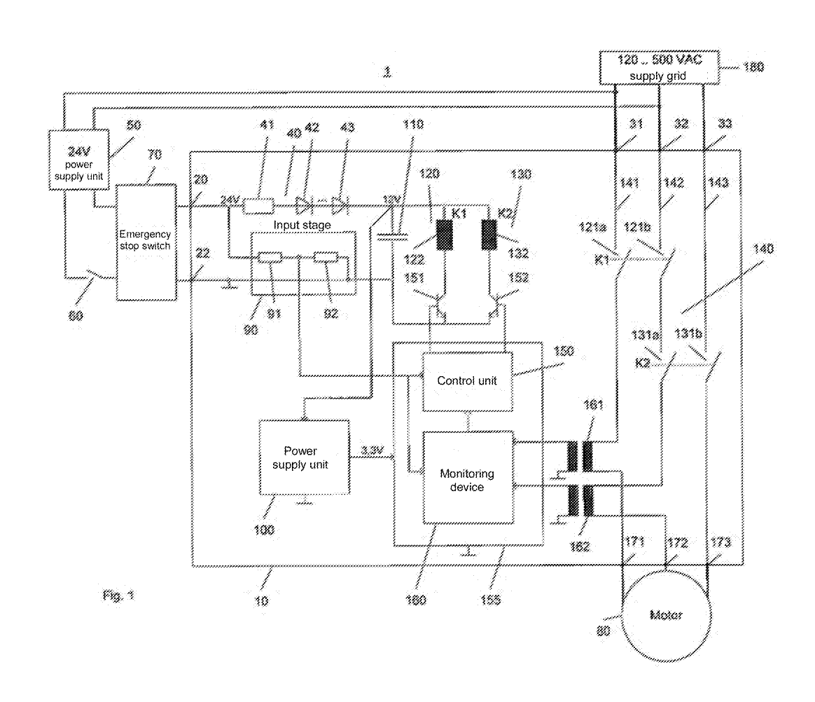

FIG. 1 shows an example of a switching device 10 for switching an electrical load 80, which in the present example is a three-phase motor, on or off. The switching device 10 has a first terminal with, for example, two connecting terminals 20 and 22 to which a first supply voltage may be applied via a safety switch 70. The connecting terminal 22 is connected to ground, for example. The first supply voltage may be delivered by a supply source 50 which may provide a direct voltage of 24 V, for example. In the present example, the supply source 50 is an external power supply unit 50, for example, which may, for example, be connected to two phases of a three-phase low-voltage power grid 180. The external power supply unit 50 may be connected to the connecting terminals 20 and 22 via a main switch 60 and the safety switch 70, which is connected to the connecting terminals 20 and 22. The safety switch 70 is implemented as an emergency stop switch in the example shown.

The switching device 10 has a second terminal for applying a second supply voltage which may feed the electrical load 80. The second supply voltage is provided, for example, by the illustrated three-phase low-voltage power grid 180, whose three conductors may be connected to the three connecting terminals 31, 32, and 33 of the second terminal. The electrical load 80 may be connected to a third terminal, which has three connecting terminals 171, 172, and 173, for example. To allow the electrical load 80 to be connected to the low-voltage power grid 180, the switching device has a power output stage that is connected between the second terminal, i.e., the connecting terminals 31 through 33, and the third terminal, i.e., the connecting terminals 171 through 173. The power output stage has at least one electromechanical switch and at least one further switch for closing or interrupting a connection 140 between the second and third terminals. In the present example, an electromechanical switch 120, and also an electromechanical switch 130 as a further switch, which have, for example, two positively driven switching contacts 121a, 121b and 131a, 131b, respectively, are implemented in the switching device 10. A semiconductor switch may also be used as a further switch.

The power output stage is designed as a multichannel and multiphase power output stage in the described example. In the present example, the power output stage has a two-channel design due to the fact that two independently controllable switches 120 and 130 are used. The power output stage also has a three-phase design due to the fact that it is connected to the three-phase supply grid 180.

The connection 140 is formed by three current paths 141, 142, and 143 in the described example. The current path 141 runs between the connecting terminals 31 and 171, the current path 142 runs between the connecting terminals 32 and 172, and the current path 143 runs between the connecting terminals 33 and 173. The switching contacts 121a and 121b of the electromechanical switch 120 are switched into the current paths 141 and 142, while the switching contacts 131a and 131b of the electromechanical switch 130 are switched into the current paths 142 and 143. The two electromechanical switches 120 and 130 may each be designed as relays, which are symbolically illustrated, respectively, by an exciter coil 122 or 132 and the switching contacts 121a and 121b or 131a and 131b. In addition, the switching device 10 has a control unit 150, whose operating principle is explained in greater detail below.

Connected to the connecting terminals 20 and 22 of the first terminal is an energy store 110 internal to the device, which is chargeable to a predetermined excitation or control energy, for example 12 V, by the first supply voltage which is appliable to the connecting terminals 20 and 22. For this purpose, a unit 40 for protecting against polarity reversal and for setting the excitation energy may be connected between the connecting terminal 20 and a terminal of the energy store 110. The unit 40 may have at least one ohmic resistor 41 and multiple diodes 42 and 43, which are preferably all connected in series. The energy store 110 may be a capacitor. The energy store 110 may thus be charged via the unit 40 to an energy level of 12 V, for example, as soon as the external power supply unit 50, and thus the first supply voltage, is connected to the connecting terminals 20, 22.

For the case that the control unit 150 requires an operating voltage that is lower than the voltage provided by the energy store 110, a power supply unit 100 internal to the device which can supply the control unit 150 with an operating voltage of 3.3 V, for example, may be connected to the connecting terminals 20, 22 of the first terminal and to the energy store 150. When the first supply voltage is switched off, the control unit 150 may be temporarily fed by the energy store 110.

The internal power supply unit 100 of the switching device 10 may have a conventional design, and may contain a voltage regulator, for example.

If the at least one electromechanical switch 120, the at least one further switch 130, and the control unit 150 require essentially the same operating voltage of 5 V, for example, the power supply unit 100 may be dispensed with, it being possible to dimension the energy store 110 in such a way that it is able to provide a voltage of 5 V, for example, for a predetermined period of time.

In addition, at least two switching units 151 and 152 that are controllable by the control unit 150 are provided which are able to connect the at least one electromechanical switch 120 and the at least one further switch 130 to the connecting terminals 20, 22 and to the energy store 110. The switching units 151 and 152 are advantageously designed as semiconductor switches, for example NPN transistors. In this case, the base of the transistor 151 is connected to an output of the control unit 150, the collector is connected to a terminal of the exciter coil 122, and the emitter is connected to the ground terminal 22, while the base of the transistor 151 is connected to a further output of the control unit 150, the collector is connected to a terminal of the exciter coil 132, and the emitter is connected to the ground terminal 22. The energy store 110 may thus be connected in parallel to the exciter coils 122 and 132. In other words, the energy store 110 may be connected into the control circuit of the particular electromechanical switch 120 or 130 by controlling the control unit 150 via the transistors 151 and 152.

Connected to the connecting terminals 20 and 22 of the first terminal is an input stage 90 which may provide a digital control signal for the control unit 150, indicating the application or non-application of the first supply voltage. The input stage 90 may be made up of a voltage divider that includes, for example, two ohmic resistors 91 and 92. A terminal of the resistor 91 is connected to the connecting terminal 20, while a terminal of the resistor 92 is connected to the ground terminal 22. The shared point of connection of the resistors 91 and 92 is connected to an input of the control unit 150, which is supplied with the digital control signal of the input stage 90. The input stage 90 delivers a high level to the control unit 150 when the first supply voltage is applied to the connecting terminals 20, 22, and a low level when the first supply voltage is not applied to the connecting terminals 20, 22. The control unit 150 is designed for recognizing the application or non-application of the first supply voltage as a function of the received high or low level of the digital control signal. A voltage of approximately 3.3 V preferably drops at the resistor 92 when the first supply voltage is applied, whereas essentially no voltage drops at the resistor 92 when the first supply voltage is not applied. The control unit 150 is also designed for controlling the at least two switching units 151 and 152, as a function of the digital control signal of the input stage 90, in such a way that when the first supply voltage is applied to the connecting terminals 20, 22 of the first terminal, the electromechanical switches 120 and 130 or their switching contacts close, and that as soon as the first supply voltage has been disconnected from the connecting terminals 20 and 22, the energy store 110 may supply its stored energy to the at least one electromechanical switch, in the present example the switch 120, for the predetermined time period, so that the at least one electromechanical switch 120 remains closed during the predetermined time period. The predetermined time period corresponds essentially to the time up until when the energy of the energy store 110 has fallen to a quantity that is still sufficient to keep the electromechanical switch 120 in the excited, i.e., closed, state.

Optionally, a monitoring device 160 may be provided which may be connected to the output of the input stage 90, and which is supplied with the operating voltage by the internal power supply unit 100, if present. The monitoring device 160 is coupled to the two current paths 141 and 142, for example, via transformers 161 and 162, respectively. Depending on the implementation, the monitoring device 160 may contain a motor model with which the temperature of the motor 80 may be monitored. The result from the monitoring device 160 may be supplied to the control unit 150, which may then control the switching device as a function of an implemented sequence program.

As illustrated in FIG. 1, the control unit 150 and the monitoring device 160 may be part of an electronic module 155 that is designed, for example, as a microcontroller or as an FPGA. It is conceivable for the control unit 150 or its functions to be implemented as software. The module 155, if present, receives the operating voltage from the internal power supply unit 100 or directly from the energy store 110.

The switching device 10, the electrical load 80, the supply grid 180, the external power supply unit 50, and optionally the main switch 60 and the safety switch 70, together form a system for switching an electrical load on or off. It is noted that the example of the switching device 10 allows the electrical load 80 to be safely switched off.

It is further noted that the switching units 151 and 152 may be designed as energy flow limiting devices, for example as optocouplers, wherein the input stage 90 may also be coupled to the control unit 150 via an energy flow limiting device, for example an optocoupler.

The operating principle of the system 1 shown by way of example in FIG. 1 is explained in greater detail below.

It is assumed that the main switch 60 and the contacts of the emergency stop switch 70 are closed, so that the supply voltage provided by the external power supply unit 50 is present at the connecting terminals 20 and 22. Consequently, the input stage 90 supplies the control unit 150 and the monitoring device 160 with a digital control signal in the form of a high level. The capacitor 110 is charged to the predetermined excitation energy of 12 V, for example, via the electrical resistor 41 and the diodes 42 and 43.

In response to the digital control signal coming from the input stage 90, the control unit 150 provides a control signal to each of the two base terminals of the transistors 151 and 152; the control signals switch the two transistors 151 and 152 into a conductive state. The control unit 150 thus ensures that the first supply voltage that is present at the connecting terminals 20 and 22 is present at the two exciter coils 122 and 132, and that the relays 120 and 130 or their switching contacts are thus closed. In this way the electrical load 80 is connected to the supply grid 180 and thus switched on.

As long as the monitoring device 160 has not signaled a critical state to the control unit 150, the main switch 60 remains closed, the emergency stop switch 70 is not actuated, and the motor 80 remains switched on.

The case is now assumed that an operator actuates the emergency stop switch 70. This causes the external power supply unit 50 to be disconnected from the first terminal, i.e., the connecting terminals 20 and 22. The input stage 90 subsequently delivers a digital control signal, in the form of a low level, to the control unit 150, which is interpreted by the control unit 150 to mean that the external power supply unit 50 has now been disconnected from the switching device 10.

A sequence control, for example, is programmed in the control unit 150, and ensures that for a specified time period the electromechanical switch 120 initially is still to be in the excited state, i.e., to remain in the closed state, whereas the electromechanical switch 130 is to be immediately deactivated, so that the switching contacts 131a and 131b are opened. This means that the control unit 150 keeps the transistor 151 conductive for a predetermined time period, so that the capacitor 110 now supplies the exciter coil 122 with the predefined excitation energy, and the switching contacts 121a and 121b thus remain closed for the predetermined time period. At the same time, the control unit 150 generates a control signal for the transistor 152 in order to block it. As a result, the energy of the capacitor 110 is not applied to the exciter coil 132, and the switching contacts 131a and 131b are opened.

It is noted that when the external power supply unit 150 is disconnected, the energy of the capacitor 110 is also supplied to the internal power supply unit 100, so that the control unit 150 as well as the monitoring device 160 are supplied with the operating voltage, 3.3 V, for example, for the predetermined time period. Essentially when the predetermined time period elapses, the transistor 151 is then also controlled into the blocking state by the control unit 150, so that the switching contacts 121a and 121b are also opened.

In this way, the electrical load 80 may be safely disconnected from the supply grid 180 by means of the switching device 10.

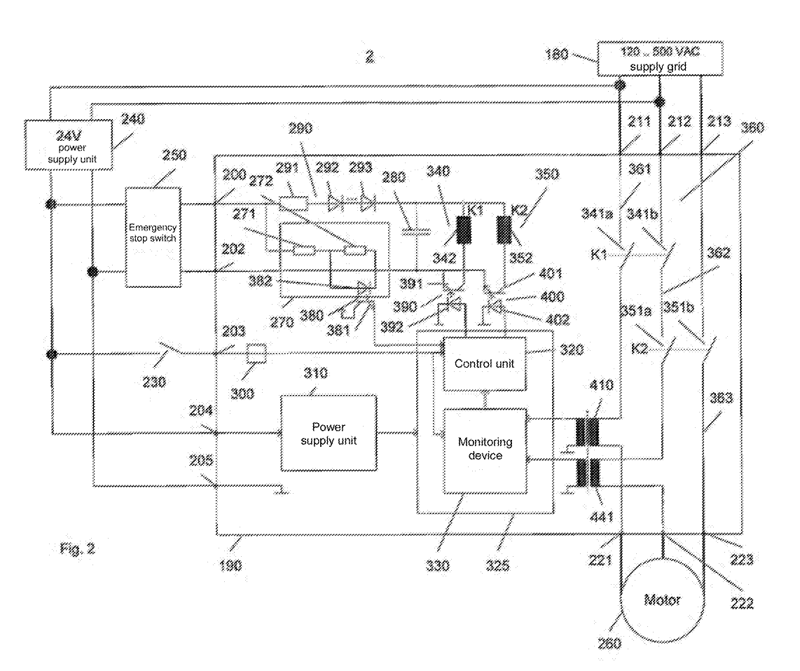

FIG. 2 shows another example of a switching device 190 for switching an electrical load 260, which in the present example is a three-phase motor, on or off. The switching device 190 has a first terminal with, for example, two connecting terminals 200 and 202 to which a first supply voltage may be applied via a safety switch 250. The first supply voltage may be delivered by a supply source 240 that may provide a direct voltage of 24 V, for example.

In the present example, the supply source 240, for example, is an external power supply unit which may, for example, be connected to two phases of a three-phase low-voltage power grid 180. The external power supply unit 240 may be connected to the connecting terminals 200 and 202 via the safety switch 250, which is connected to the connecting terminals 200 and 202. The safety switch 250 is implemented as an emergency stop switch in the example shown.

The switching device 190 has a second terminal with two connecting terminals 204 and 205, for example, for applying the first supply voltage, as shown, or a second supply voltage. The connecting terminal 205 may be connected to ground.

The switching device 190 has a third terminal for applying a second supply voltage which may feed the electrical load 260. The second supply voltage is provided, for example, by the illustrated three-phase low-voltage power grid 180, whose three conductors may be connected to three connecting terminals 211, 212, and 213 of the second terminal. The electrical load 260 may be connected to a fourth terminal that has three connecting terminals 221, 222, and 223, for example.

To allow the electrical load 260 to be connected to the low-voltage power grid 180, the switching device 190 has a power output stage that is connected between the third terminal, i.e., the connecting terminals 211 through 213, and the fourth terminal, i.e., the connecting terminals 221 through 223. The power output stage has at least one electromechanical switch and at least one further switch for closing or interrupting a connection 360 between the third and fourth terminals. In the present example, an electromechanical switch 340, and also an electromechanical switch 350 as a further switch, which have, for example, two positively driven switching contacts 341a, 341b and 351a, 351b, respectively, are implemented in the switching device 190. A semiconductor switch may also be used as a further switch.

The power output stage is designed as a multiphase and multichannel power output stage in the described example. In the present example, the power output stage has a two-channel design, since two independently controllable switches 340 and 350 are used. The power output stage also has a three-phase design, since it is connected to the three-phase supply grid 260.

The connection 360 is formed by three current paths 361, 362, and 363 in the described example. The current path 361 runs between the connecting terminals 211 and 221, the current path 362 runs between the connecting terminals 212 and 222, and the current path 363 runs between the connecting terminals 213 and 223. The switching contacts 341a and 341b of the electromechanical switch 120 are switched into the current paths 361 and 362, while the switching contacts 131a and 131b of the electromechanical switch 340 are switched into the current paths 362 and 362. The two electromechanical switches 340 and 350 may each be designed as relays, which are symbolically illustrated, respectively, by an exciter coil 342 or 352 and the switching contacts 341a and 341b or 351a and 351b. In addition, the switching device 190 has a control unit 320, whose operating principle is explained in greater detail below.

Connected to the connecting terminals 200 and 202 of the first terminal is an energy store 280 internal to the device, which is chargeable to a predetermined excitation or control energy, for example 12 V, by the first supply voltage which is appliable to the connecting terminals 200 and 202. For this purpose, a unit 290 for protecting against polarity reversal and for setting the excitation energy may be connected between the connecting terminal 200 and a terminal of the energy store 280. The unit 290 may have at least one ohmic resistor 291 and multiple diodes 292 and 293, which are preferably all connected in series. The energy store 280 may be a capacitor. The energy store 280 may thus be charged via the unit 290 to an energy level of 12 V, for example, as soon as the external power supply unit 240, and thus the first supply voltage, is connected to the connecting terminals 200, 202.

A power supply unit 310 internal to the device, which the control unit 320 may supply with an operating voltage of 3.3 V, for example, during operation, is connected to the connecting terminals 204, 205 of the second terminal. The operating voltage may be lower than the voltage which is temporarily provided by the energy store 280 and which is required for controlling the electromechanical switches 340 and 350. It must be ensured that the power supply unit 310 internal to the device remains connected to the external power supply unit 240, even when the safety switching device 250 has been actuated and its switching contacts have thus been opened.

The internal power supply unit 310 and the external power supply unit 240 may each have a conventional design, and may each contain a voltage regulator, for example.

In addition, at least two switching units 391, 401 that are controllable by the control unit 320 are provided which are able to connect the at least one electromechanical switch 340 and the at least one further switch 350 to the connecting terminals 200, 202 and to the energy store 280. The switching units 391 and 401 are a part of a first energy flow limiting device 390 and 400, respectively. The energy flow limiting devices 390 and 400 are preferably an optocoupler in each case. In this case, the switching unit 391 with regard to the energy flow limiting device 390, designed as an optocoupler, forms an optical receiver, while the switching unit 401 with regard to the energy flow limiting device 400, designed as an optocoupler, forms an optical receiver. The optical receivers may be designed as phototransistors or photodiodes. The optical receiver 391 is connected between a terminal of the exciter coil 342 and the connecting terminal 202, which may be connected to ground, whereas the optical receiver 401 is connected between a terminal of the exciter coil 352 and the connecting terminal 202. The energy flow limiting device 390, designed as an optocoupler, has an optical transmitter 392 whose anode terminal is connected to an output of the control unit 320 and whose cathode terminal is connected to ground and, for example, connected to the connecting terminal 205. The energy flow limiting device 400, designed as an optocoupler, has an optical transmitter 402 whose anode terminal is connected to an output of the control unit 320 and whose cathode terminal is connected to ground and, for example, connected to the connecting terminal 205. The optical transmitters may be designed as LEDs or laser diodes. The energy store 280 may thus be connected in parallel to the exciter coils 342 and 352. In other words, the energy store 280, via control by the control unit 320, may be connected via the energy flow limiting devices 390 and 400 into the control circuit of the respective electromechanical switch 340 or 350.

Connected to the connecting terminals 200 and 202 of the first terminal is a first input stage 270 that may provide a digital control signal for the control unit 320, indicating the application or non-application of the first supply voltage. The input stage 270 may be made up of a voltage divider that includes, for example, two ohmic resistors 271 and 272. A terminal of the resistor 271 is connected to the connecting terminal 200, while a terminal of the resistor 272 is connected to the connecting terminal 202. The shared point of connection of the resistors 271 and 272 is connected to an input of the control unit 320 which is supplied with the digital control signal of the input stage 270. The second energy flow limiting device 380 may likewise be designed as am optocoupler. In this case, an optical transmitter 382 is connected, for example, in parallel to the resistor 272, it being possible to connect the cathode terminal to the connecting terminal 202. The optical transmitter 382 may be an integral part of the input stage 270, which may be an integrated module. The optical receiver 381 of the energy flow limiting device 380 is connected on the one hand to an input of the control unit 320, and on the other hand to a reference potential that is present at the connecting terminal 200, for example. If the optical receiver is a phototransistor, the emitter terminal is connected to ground, and the collector terminal is connected to the input of the control unit 320, as shown in FIG. 2.

The primary task of the energy flow limiting devices 380 through 400, which may also be referred to as energy flow barriers, is to provide that essentially little or no energy from the terminal 204 and 205 and, if present, from a fifth terminal 203, reaches the first terminals 200 and 202, thus ensuring that the at least one electromechanical switch 340 and the at least one further switch 350 can be operated only via the supply voltage that is present at the first terminals 200 and 202 or the energy that is stored in the energy store 280. Faulty control of the at least one electromechanical switch 340 and of the at least one further switch 350 is thus achieved by a sufficiently high energy flow barrier between the first terminal and the second terminal. Transistors with a correspondingly large series resistor could also be used as energy flow limiting devices, thus preventing faulty control of the at least one electromechanical switch 340 and of the at least one further switch 350.

The input stage 270 delivers a high level to the control unit 320 when the first supply voltage is applied to the connecting terminals 200, 202, and delivers a low level when the first supply voltage is not applied to the connecting terminals 200, 202. The control unit 320 is designed for recognizing the application or non-application of the first supply voltage as a function of the received high or low level of the digital control signal. A voltage of approximately 3.3 V preferably drops at the resistor 272 when the first supply voltage is applied, whereas essentially no voltage drops at the resistor 272 when the first supply voltage is not applied. The control unit 320 is also designed for controlling the at least two switching units 301 and 392, as a function of the digital control signal of the input stage 270, in such a way that when the first supply voltage is applied to the connecting terminals 200, 202 of the first terminal, the electromechanical switches 340 and 350 or their switching contacts close, and that as soon as the first supply voltage has been disconnected from the connecting terminals 200 and 202, the energy store 280 may supply the stored energy to the at least one electromechanical switch 340 for the predetermined time period, so that the at least one electromechanical switch 340 remains closed during the predetermined time period. The predetermined time period corresponds essentially to the time up until when the energy of the energy store 280 has fallen to a quantity that is still sufficient to keep the electromechanical switches 340, 350 in the excited, i.e., closed, state.

A monitoring device 330 may optionally be provided which may be connected to the output of a second input stage 300 and supplied with the operating voltage by the internal power supply unit 310. The second input stage 300 is connected to a fifth terminal of the switching device 190, to which the external power supply unit 240 may be connected via a main switch 230. The output of the second input stage 300 may also be connected to an input of the control unit 320. The second input stage 300 may have a design that is similar to the first input stage 270, and may provide a digital control signal for the control unit 320 and/or the monitoring device 330 which signals the application or non-application of the first supply voltage.

The monitoring device 330 is coupled to the two current paths 361 and 362, for example, via transformers 410 and 411, respectively. Depending on the implementation, the monitoring device 330 may contain a motor model with which the temperature, for example the cooling temperature, of the motor 260 may be monitored. The result from the monitoring device 330 may be supplied to the control unit 150. If the monitoring device 330 recognizes, for example, overheating of the motor 260, it signals this state to the control unit 320, which subsequently deactivates the two optical transmitters 392 and 402, and thus disconnects the exciter coils 342 and 352 from the energy store 280 and the connecting terminals 200 and 202.

As illustrated in FIG. 2, the control unit 320 and the monitoring device 330 may be part of an electronic module 325, which may be designed as a microcontroller or as an FPGA, for example. It is conceivable for the control unit 320 or its functions to be implemented as software. The module 325 receives the operating voltage from the internal power supply unit 310.

It is noted that, in contrast to the switching device 10 shown in FIG. 1, the energy store 280 of the switching device 190 supplies only the electromechanical switches 340 and 350, and not the control unit 320 or the monitoring device 330, with energy when the first supply voltage is disconnected from the connecting terminals 200 and 202. In this case, the energy supply is also provided via the power supply unit 310 that is connected to the connecting terminals 204 and 205. The energy flow limiting devices 380, 390, and 400 ensure that the electromechanical switches 340 and 350 are not able to receive energy from the power supply unit 310, but, rather, are fed only via the connecting terminals 200 and 202 or via the energy store 280.

In particular, the switching device 190, the electrical load 260, the supply grid 180, the external power supply unit 240, and optionally the main switch 230 as well as the safety switch 250 may form a system for safely switching an electrical load on or off. It is noted that the example of the switching device 190 allows the electrical load 260 to be safely switched off.

The operating principle of the system 2 shown in FIG. 1 is explained in greater detail below.

It is assumed that the main switch 230 and the contacts of the emergency stop switch 250 are closed, so that the supply voltage provided by the external power supply unit 240 is present at the connecting terminals 200 and 202. Consequently, the first input stage 270 supplies the control unit 320 with a digital control signal in the form of a high level, in that the optocoupler 380 is activated, i.e., the optical transmitter 382 emits light to the optical receiver 381, so that the optical receiver becomes conductive, and the digital control signal that is delivered from a reference potential of for example 3.3 V, for example, is transmitted to the control unit 320. The reference potential may preferably be provided by the power supply unit 310. The second input stage 300 may supply a digital control signal to the control unit 320 and to the monitoring device 330 in the form of a high level. It is noted that the second input stage 300 may likewise be connected to the control unit 320 via an optocoupler (not illustrated) or a galvanic connection. The capacitor 280 is charged to the predetermined excitation energy of 12 V, for example, via the electrical resistor 291 and the diodes 292 and 293.

In response to the digital control signal coming from the first input stage 270 and the digital control signal coming from the second input stage 300, the control unit 320 activates the two optical transmitters 392 and 402, so that the two optical receivers 391 and 401 become electrically conductive. The control unit 320 thus ensures that the first supply voltage that is present at the connecting terminals 200 and 202 is present at the two exciter coils 342 and 352, so that the relays 340 and 350 or their switching contacts are closed. In this way the electrical load 260 is connected to the supply grid 180 and thus switched on.

As long as the monitoring device 330 has not signaled a critical state to the control unit 320, the main switch 230 remains closed, the emergency stop switch 250 is not actuated, and the motor 260 remains switched on.

The case is now assumed that an operator actuates the emergency stop switch 250. This causes the external power supply unit 240 to be disconnected from the first terminal, i.e., the connecting terminals 200 and 202. The voltage at the resistor 272 of the first input stage 270 then falls essentially to zero, so that the optical sensor 382 no longer emits light, and the associated optical receiver 381 goes into the blocking state. The control unit 320 recognizes this transition from the conductive state into the blocking state control unit 150, and interprets the associated control signal to mean that the external power supply unit 240 has now been disconnected from the switching device 190.

A sequence control, for example, is programmed in the control unit 320, and ensures that for a specified time period the electromechanical switch 340 initially is still to be in the excited state, i.e., to remain in the closed state, whereas the electromechanical switch 350 is to be immediately deactivated, so that the switching contacts 351a and 351b are opened. This means that the control unit 320 keeps the optical transmitter 392 active for a predetermined time period, so that the optical receiver 391 remains conductive, and the capacitor 280 now supplies the exciter coil 342 with the predefined excitation energy, and the switching contacts 341a and 341b thus remain closed for the predetermined time period.

At the same time, the control unit 320 generates a control signal for the optical transmitter 402 in order to deactivate it. The optical receiver 401 is thus blocked, the energy of the capacitor 280 is not applied to the exciter coil 352, and the switching contacts 351a and 351b are opened.

It is noted that when the power supply unit 240 is disconnected, the capacitor 280 provides energy only for the electromechanical switches 340 and 350. The energy supply to the control unit 320 is provided only by the internal power supply unit 310. Essentially when the predetermined time period elapses, the optical transmitter 392 is then also deactivated by the control unit 320, so that the optical receiver 391 goes into the blocking state, the exciter coil 342 is disconnected from the energy store 280, and the switching contacts 341a and 341b are opened.

In this way the electrical load 260 may be safely disconnected from the supply grid 180 by means of the switching device 190.

It is further noted that the control unit 320 may be designed to deactivate the two optical transmitters 392 and 402, simultaneously or in a time-delayed manner, when it recognizes that the main switch 230 has been opened. Similarly, the control unit 320 may cause the optical transmitters 392 and 402 to be deactivated, simultaneously or in a time-delayed manner, when the monitoring device 330 signals an error message to the control unit 320.

### LIST OF REFERENCE NUMERALS

1 system for switching an electrical load on or off

2 system for switching an electrical load on or off

10 switching device

20, 22 connecting terminals of the first terminal

31-33 connecting terminals of the second terminal

40 polarity reversal protection and energy setting device

41 electrical resistor

42, 43 diodes

50 energy supply source, for example an external 24-V power supply unit

60 main switch for switching an electrical load on and off

70 safety switch

80 electrical load, for example a three-phase motor

90 input stage

91, 92 resistors of a voltage divider

100 internal power supply unit

110 energy store

120 electromechanical switch, in particular a relay

121a switching contact of the electromechanical switch

121b switching contact of the electromechanical switch

122 exciter coil of the electromechanical switch

130 electromechanical switch, in particular a relay

131a switching contact of the electromechanical switch

131b switching contact of the electromechanical switch

132 exciter coil of the electromechanical switch

140 connection between the second and third terminals

141-143 current path

150 control unit

151 switching transistor

152 switching transistor

155 electronic component

160 monitoring device

161, 162 transformer

171-173 connecting terminals of the third terminal

180 supply grid, for example a three-phase low-voltage power grid

190 switching device

200, 202 connecting terminals of the first terminal

203 connecting terminal of the fifth terminal

204, 205 connecting terminals of the second terminal

211-213 connecting terminals of the third terminal

221-223 connecting terminals of the fourth terminal

230 main switch for switching an electrical load on and off

240 energy supply source, for example an external 24-V power supply unit

250 safety switch

260 electrical load

270 first input stage

271, 272 voltage divider

280 energy store

290 polarity reversal protection and energy setting device

291 electrical resistor

292, 293 diodes

300 second input stage

310 internal power supply unit

320 control unit

325 electronic component, for example a microcontroller

330 monitoring device

340 electromechanical switch

341a switching contacts

341b switching contacts

342 exciter coil

350 electromechanical switch

351a switching contacts

351b switching contacts

352 exciter coil

360 connection between the third and fourth terminals

361-363 current paths

380 optocoupler

381 optical receiver, for example a phototransistor

382 optical transmitter, for example a laser diode

390 optocoupler

391 optical receiver, for example a phototransistor

392 optical transmitter, for example a laser diode

400 optocoupler

401 optical receiver, for example a phototransistor

402 optical transmitter, for example a laser diode

410 transformer

411 transformer

1. A switching device for switching an electrical load on or off, the switching device comprising:
a first terminal for applying a first supply voltage via a safety switching device
a second terminal for applying a second supply voltage which may feed an electrical load,
a third terminal for connecting an electrical load,
a control unit,
a power output stage that is connected between the second and third terminals, and at least one electromechanical switch and at least one further switch for closing or interrupting a connection between the second and third terminals,
an energy store which is connected to the first terminal and which is chargeable to a predetermined energy level via the first terminal,
at least two switching units which are controllable by the control unit and which in each case are able to connect the at least one electromechanical switch or the at least one further switch to the first terminal and to the energy store,
an input stage, connected to the first terminal, which may provide a digital control signal for the control unit which signals the application or the non-application of the first supply voltage, wherein
the control unit (454) is designed for controlling the at least two switching units, as a function of the digital control signal, in such a way that when the first supply voltage is present at the first terminal, the at least one electromechanical switch and the at least one further switch close, and that as soon as the first supply voltage has been disconnected from the first terminal, the energy store may supply the stored energy to the at least one electromechanical switch for the predetermined time period, so that the at least one electromechanical switch remains closed during the predetermined time period.

2. A switching device for switching an electrical load on or off, wherein the switching device comprising:
a first terminal for applying a first supply voltage via a safety switching device,
a second terminal for applying the first supply voltage or a second supply voltage,
a third terminal for applying a third supply voltage which may feed an electrical load,
a fourth terminal for connecting an electrical load,
a control unit,
a power output stage which is connected between the third and fourth terminals and which has at least one electromechanical switch and at least one further switch for closing or interrupting a connection between the third and fourth terminals,
an energy store which is connected to the first terminal and which is chargeable to a predetermined energy level via the first terminal,
a power supply unit, connected to the second terminal, which may supply the control unit with an operating voltage,
at least two switching units which are controllable by the control unit and which may connect the at least one electromechanical switch and the at least one further switch to the first terminal and to the energy store wherein the at least two switching units are each part of a first energy flow limiting device,
a first input stage connected to the first terminal, which may provide a digital control signal for the control unit which signals the application or non-application of the first supply voltage, wherein the first input stage is coupled to the control unit via a second energy flow limiting device, the control unit being designed for controlling the at least two switching units, as a function of the digital control signal, in such a way that when the first supply voltage is present at the first terminal, the at least one electromechanical switch and the at least one further switch close, and that as soon as the first supply voltage has been disconnected from the first terminal, the energy store may supply the stored energy to the at least one electromechanical switch for a predetermined time period, so that the at least one electromechanical switch remains closed during the predetermined time period.

3. The switching device according to claim 2, wherein the first energy flow limiting devices and the second energy flow limiting device are designed in each case as optocouplers.

4. The switching device according to claim 2, further comprising a fifth terminal for applying the first supply voltage, and a second input stage, associated with the fifth terminal which may provide a digital control signal for the control unit, which signals the application or the non-application of the first supply voltage.

5. The switching device according to claim 1, wherein the switching units are each part of an energy flow limiting device, in particular an optocoupler, and/or that the input stage is coupled to the control unit via an energy flow limiting device, in particular an optocoupler.

6. The switching device according to claim 1, further comprising a power supply unit which is connected to the first terminal and to the energy store, and which may also supply the control unit with an operating voltage for a predetermined time period when the first supply voltage has been switched off.

7. The switching device according to claim 1, further comprising a monitoring device that is connected to the power supply unit and to the control unit.

8. The switching device according to claim 1, further comprising a unit, connected to the first terminal for protecting against polarity reversal and/or for setting the predefined excitation energy to which the energy store is chargeable.

9. The switching device according to claim 1, wherein the at least one further switch is an electromechanical switch or a semiconductor switch.

10. A system for switching an electrical load on or off, comprising:
a switching device according to claim 1,
a first energy supply source that is connectable to the first terminal,
a second energy supply source that is connectable to the second terminal or third terminal, and
an electrical load that is connectable to the third terminal or fourth terminal.

11. The switching device according to claim 2, further comprising a monitoring device that is connected to the power supply unit and to the control unit.

12. The switching device according to claim 2, further comprising a unit, connected to the first terminal, for protecting against polarity reversal and/or for setting the predefined excitation energy to which the energy store is chargeable.

13. The switching device according to claim 2, wherein the at least one further switch is an electromechanical switch or a semiconductor switch.

14. A system for switching an electrical load on or off, comprising:
a switching device according to claim 2,
a first energy supply source that is connectable to the first terminal,
a second energy supply source that is connectable to the second terminal or third terminal, and
an electrical load that is connectable to the third terminal or fourth terminal.
